(19) United States
(12) Patent Application Publication
(10) Pub. No.: US 2014/0016796 A1
(43) Pub. Date: Jan. 16, 2014

(54) PORTABLE WIRELESS EARPHONE SYSTEM

(71) Applicant: Ann L. Maust, (US)

(72) Inventor: Robert J. Maust, Jacksonville, FL (US)

(21) Appl. No.: 13/939,156

(22) Filed: Jul. 10, 2013

Related U.S. Application Data
(60) Provisional application No. 61/669,937, filed on Jul. 10, 2012.

(51) Int. Cl. H04R 1/10

(52) U.S. Cl. CPC H04R 1/1041
USPC 381/74

(57) ABSTRACT

A portable wireless earphone system includes a wireless transmitter unit (i.e., hub) plugged into a conventional portable audio device and one or more paired wireless receiver units, each of which mates with conventional earphones. Each receiver unit houses a spool that contains excess earphone cord. The receiver unit houses a recessed audio port that protects the male plug of earphones. An ejector or deflector facilitates removal of the male plug. Optical communication channels facilitate pairing. Lossless PCM encoding with selective amplification of low volume sounds faithfully reproduces audio.

### RELATED APPLICATION

This application is a Nonprovisional of and claims the benefit of priority of U.S. Provisional Application 61/669,937 filed Jul. 10, 2012, the entire contents of which are incorporated herein.

### FIELD OF THE INVENTION

This invention relates generally to wireless earphones, and, more particularly, to a portable wireless earphone system including a wireless transmitter unit that plugs into a conventional audio output port of a portable audio device and a corresponding wireless receiver unit integrated with earphones.

### BACKGROUND

Digital audio players are popular. Typically, the players include an audio output port, such as a 3.5 mm port. Earphones equipped with a corresponding male plug connect to the port. Unfortunately, the cord that extends between the plug and the earphones is inconvenient and fragile. As the cords tend to be several feet long, excess cord between the audio player and earphones tends to dangle and snag. Additionally, because the conductive core of the cords is very thin and the insulation is resilient, stretching the cord tends to break the thin conductive core, rendering the earphones useless.

Another shortcoming of devices with male audio plugs is the risk of breakage. If the plug is bent while in a port, the tip of the plug may break off in the port. Such breakage not only renders the earphones useless, but also prevents further use of the player. The risk of such breakage increases with exposure of the earphone connection.

Another shortcoming of such devices is risk of breakage of wires. Earphone cords contain thin easily breakable conductive core wires. Pulling on the cord during a snag or to dislodge a plug, risks breakage of the conductive core. Upon such breakage, the earphones are inoperable.

In recent years, wireless earphones, such as Bluetooth earpieces and headsets, have emerged. While such devices eliminate cords, they only work with Bluetooth capable players. Additionally, they tend to be cumbersome to pair, limited in pairing capabilities and inefficient in consuming battery power.

Additionally, conventional wireless earphones tend to reproduce low volume audio poorly. The poor reproduction results from the digital encoding of analog signals.

The invention is directed to overcoming one or more of the problems and solving one or more of the needs as set forth above.

### SUMMARY OF THE INVENTION

To solve one or more of the problems set forth above, in an exemplary implementation of the invention, a portable wireless earphone system includes a wireless transmitter unit that plugs into a conventional audio output port of a portable audio device and a corresponding wireless receiver unit equipped with conventional earphones. The transmitter unit plugs into any conventional audio output port. The receiver unit accepts conventional earphones. The receiver unit houses a spool that contains excess cord of earphones. The receiver unit also houses an audio port that engages the male plug of earphones. The audio port may include an ejector pin or zero-insertion-force mechanism to facilitate insertion and/or ejection of the male plug. The system utilizes lossless PCM encoding with selective amplification and de-amplification of low volume sounds to faithfully reproduce audio. The system utilizes a power management schemes to reduce or minimize on-time when audio is not being transmitted.

In one exemplary embodiment, a wireless audio transmission system for an earphone having a wire (or pair of wires) connecting an audio output device (e.g., one or more earphones or earbuds or headphones) to an earphone plug (e.g., an audio plug), and a portable audio player with a first analog audio output port through which the player communicates first analog audio signals, is provided. The wireless audio transmission system includes a transmitting unit and a receiving unit. The transmitting unit includes an audio plug configured to operably couple the transmitting unit to the audio player by mating with the first analog audio output port of the audio player. The transmitting unit also includes an audio transmitting module generating, from the first analog audio signals, audio data, and wirelessly transmitting the audio data. The receiving unit includes a housing having a plug channel. The receiving unit also includes a second analog audio output port recessed in the housing in the plug channel and configured to mate with the earphone plug. The plug channel contains and shields the earphone plug in the channel when the earphone plug mates with the second analog audio output port. The receiving unit also includes an audio receiving module receiving audio data wirelessly transmitted by the transmitting unit, and generating a second analog audio output from the received audio data, and communicating the second analog audio output through the second analog audio output port. Audible audio from the second analog audio output is emitted by the audio output device.

In one embodiment, a plug ejector is provided to urge the earphone plug from the second analog audio output port in the receiving unit. The ejector is moveable from a first position to a second position. In the second position the ejector urges the earphone plug out of the second analog audio output port. In the first position the ejector does not urge the earphone plug out of the second analog audio output port. The ejector may include an ejection pin linearly moveable from the first position to the second position, with a pivoting control lever coupled to the ejection pin, or a rotary control moving the ejection pin, or a sliding control moving the ejection pin between the first position and the second position. Alternatively, the ejector may include an inclined plane moveable between the first position and the second position, or a cam rotatable between the first position and the second position, or a lever pivotable between the first position and the second position. In each case, a mechanism is provided to urge (i.e., push) the plug out of the socket comprising the second analog audio output port.

In addition to or in lieu of the ejector, in another embodiment, a deflector is provided to deflect one or more of the biased conductive contacts in the second analog audio output port. The biased conductive contacts hold the plug in the socket of the port. The contacts are deflectable from a released position to an engaged position. They are in an engaged position when undisturbed. In the engaged position the contacts abut the conductive terminal portion of earphone plug, thereby resisting removal of the earphone plug from the second analog audio output port. The deflector controllably moves the biased conductive contact from the engaged position to the released position to facilitate removal of the earphone plug from the second analog audio output port. The ejector and deflector facilitate removal of the plug without damage that can be caused by pulling on the wires.

A spool is contained in the housing of the receiving unit. The spool contains a portion of the wire (e.g., excess wire) wound thereupon. The housing includes one or more openings for the wire.

The housing includes a removable panel providing access to the contained spool. The removable panel has an interior side facing the spool and an exterior side. The exterior side may include a clip, a stand, a suction cup or a magnet for supporting the receiving unit on an object.

In one embodiment, optical emitters and receivers are provided for optical communication between the transmitting and receiving units, such as for pairing the units. For example, a first optical emitter and a first optical receiver may be provided on the transmitting unit, while a second optical emitter and a second optical may be provided on the receiving unit, to enable optical communication therebetween.

To conserve battery power, the transmitting unit operates intermittently until the receiving unit transmits a signal indicating that it is powered up and ready to play audio. For example, the audio receiving module of the receiving unit may communicate an operating signal to the audio transmitting module of the transmitting unit when the receiving unit is operating. The transmitting module of the transmitting unit will operating intermittently (e.g., very briefly) until the audio receiving module of the receiving unit communicates the operating signal to the transmitting module of the transmitting unit.

To pair the units, the receiving unit provides a unique ID or address to the transmitting unit. User controls (e.g., user-actuatable input controls such as buttons, switches or other user interface controls) are provided to initiate pairing between the units. More than one receiving unit may be paired to the transmitting unit. When audio data is transmitted, the unique ID or address for each paired receiving unit is included in the data stream. Only receiving units having an ID in the data stream will play the audio data.

To enhance the fidelity of the sound, the transmitting module of the transmitting unit may amplify the audio data in PCM coding to a determined level of amplification. The amplified audio data and determined level of amplification may be included in the stream transmitted from the transmitting unit to the receiving unit.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram of an electronics module comprising an exemplary transmitter unit according to principles of the invention.

FIG. 2 is a high level block diagram of an electronics module comprising an exemplary receiver unit according to principles of the invention.

FIG. 3 is a perspective view of an exterior of an exemplary transmitter unit, also known as a hub, according to principles of the invention.

FIG. 4 is another perspective view of an exterior of an exemplary transmitter unit according to principles of the invention.

FIG. 5 is a plan view of an exterior of an exemplary transmitter unit connected to the output port of a portable audio player, such as a smartphone, according to principles of the invention.

FIG. 6 is a perspective view of an exterior of an exemplary transmitter unit connected to the output port of a portable audio player, such as a smartphone, according to principles of the invention.

FIG. 6A is a perspective view of an exterior of an exemplary receiver unit connected to the output port of a portable audio player, such as an mp3 player, according to principles of the invention.

FIG. 7 is a perspective view of an exterior of an exemplary receiver unit according to principles of the invention.

FIG. 8 is a side view of an exterior of an exemplary receiver unit according to principles of the invention.

FIG. 9 is another side view of an exterior of an exemplary receiver unit according to principles of the invention.

FIG. 10 is a perspective view of an exterior of an exemplary receiver unit with a bottom cover panel removed according to principles of the invention.

FIG. 11 is a perspective view of an exterior of an exemplary receiver unit with a spool removed according to principles of the invention.

FIG. 12 is a perspective view of an exterior of an exemplary receiver unit connected to earphones according to principles of the invention.

FIG. 13 provides various views of exemplary cover panels for an exemplary receiver according to principles of the invention.

FIG. 14 is a schematic that conceptually illustrates a lever-actuated ejector pin for an audio port of a receiver unit, according to principles of the invention.

FIG. 15 is a schematic that conceptually illustrates a lever-actuated contact release mechanism for an audio port of a receiver unit, according to principles of the invention.

FIG. 16 is a high level block diagram of a method of coupling a receiving unit to a transmitting unit, according to principles of the invention.

FIG. 17 is a high level block diagram of a method of clearing a list of authorized receiving units, according to principles of the invention.

FIG. 18 is a high level block diagram of a method of a method of communicating data between a transmitting unit and a receiving unit, according to principles of the invention.

FIG. 19 is a high level block diagram of a method of a receiving data and playing audio via a receiving unit, according to principles of the invention.

FIG. 20 is a high level block diagram of a data structure for communicating data between a transmitting unit and a receiving unit, according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

The transmitter unit creates and wirelessly communicates an audio signal to a remote receiver unit. The transmitter unit receives analog audio signals, samples the analog audio signals into a PCM data stream, modulates the PCM data stream onto a carrier and wirelessly transmits the carrier. The receiving unit receives the carrier, demodulates the PCM data stream from the carrier, and generates a reconstructed audio signal from the PCM data stream. The PCM data stream may be encoded with linear, μ-law, or A-law quantization levels.

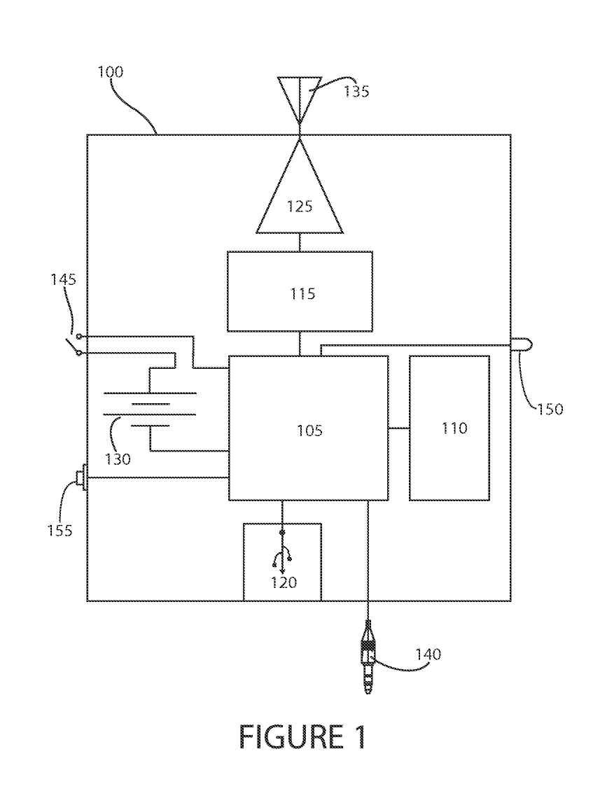

FIG. 1 provides a high level block diagram of electronic components of a wireless transmitter unit 100 (aka transmitter unit) according to an exemplary embodiment. The wireless transmitter unit 100 includes a wireless transceiver 115 (transmitter/receiver) or a wireless transmitter for encoding and communicating signals including audio data via antenna 135. The transceiver 115 may operate in conjunction with a communication standard such as 802.11, Bluetooth, 802.15.4 standard running a ZigBee or other protocol stack, ultra-wideband, RFID, IrDA, Wimax or other standard short or medium range communication protocol, or other protocol, such as a proprietary protocol. A microcontroller 105 operably coupled to the wireless transceiver 115 controls the transceiver 115 by performing various tasks.

A microcontroller 105 receives, stores and processes signals and data and generates output. The microcontroller 105 comprises a processor core, memory, and programmable input/output pins. The pins are software configurable to either an input or an output state. When configured to an input state, the pins may be used to read sensors or external signals. If the microcontroller contains an analog-to-digital converter (ADC), one more separate analog-to-digital converters may not be necessary. Each analog to digital converter converts incoming analog signals into a digital form that the microcontroller can recognize. Configured to the output state, the microcontroller pins can drive external devices (i.e., devices external to the microcontroller). If the microcontroller does not contain a digital-to-analog converter (DAC) that allows the microcontroller to output analog signals or voltage levels, then a DAC could be operably coupled between the microcontroller and any external device that requires analog input. The microcontroller 105 may include an analog-to-digital converter (ADC) to process analog (e.g., audio) signals, an audio codec (e.g., a PCM module) to encode an audio data stream, and other components available in conventional microcontrollers in the form of hardware, firmware, software and combinations of the foregoing.

An antenna 135 transmits radio signals. A transmitter/receiver (TR) switch, which may be part of the microcontroller 105, part of the transceiver 115 or a separate component, enables selection of transmit or receive mode for the antenna.

An amplifier 125, which also may be part of the microcontroller 105 or a separate component, amplifies signals that are output by the wireless transceiver and then transmitted via the antenna. Signals received via the antenna 135 may be filtered by a SAW (surface acoustic wave) filter or other filter and then input into the transceiver. The transceiver 115 processes or demodulates the received signals. By way of example and not limitation, processing steps may include down-converting the signals to an intermediate frequency and then down-converting to baseband or other frequency, digitally detecting data, extracting the data from the received modulated carrier wave, and other signal processing. Likewise, digital data to be transmitted may be received by the transceiver 115 from the microcontroller 105. The transceiver 115 may modulate digital data from the microcontroller 105 onto a selected channel or frequency or range or spectrum of frequencies for transmission through the antenna.

A battery 130, which may be disposable or rechargeable, provides electric power for the unit 100. An auxiliary power port may also be provided for supplying electric power for the unit 100.

Various components or peripherals may be operably coupled to the microcontroller. For example, memory 110, such as a volatile random access memory and/or nonvolatile flash random access memory, may store information. An input plug 140, such as a 3.5 mm TRS connector (aka audio plug) supplies analog signals from an audio output socket of an audio device, such as a portable music player. A variety of other peripherals, such as a USB (Universal Serial Bus) port 120, an on/off switch 145 and a user input device, such as button 155, may be operably coupled to the microcontroller 205.

For clarification, to the extent a transceiver is referenced herein, the transceiver may comprise a transmitter, or a receiver, or a combined transmitter/receiver. The term transceiver is used broadly herein, without limitation, to denote a transmitter, a receiver, and/or a combined transmitter/receiver.

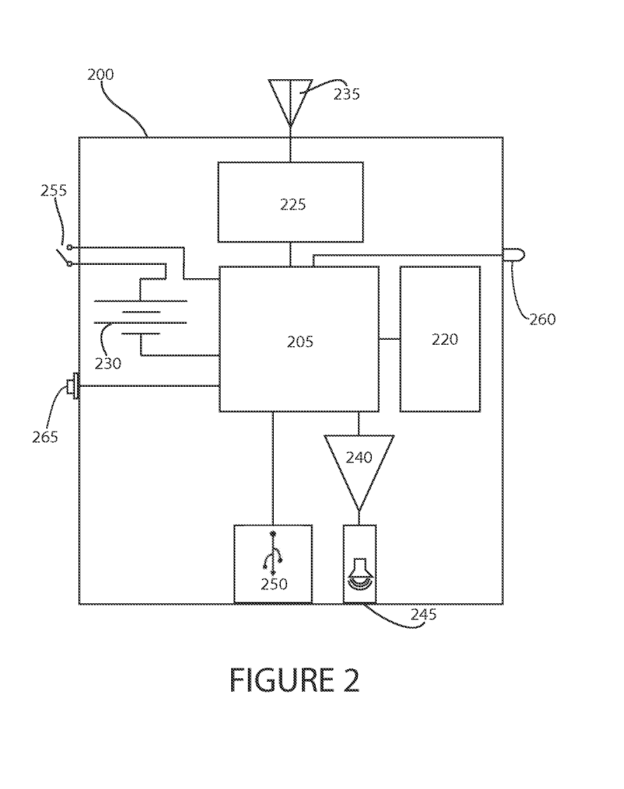

FIG. 2 provides a high level block diagram of electronic components of a wireless receiving unit 200 according to an exemplary embodiment. The wireless receiving unit 200 includes a wireless transceiver 225 or wireless receiver for receiving signals, such as an audio data stream and system management signals. A microcontroller 205 operably coupled to the wireless transceiver 225 controls the transceiver 225. The microcontroller 205 may include an analog-to-digital converter (ADC) and a digital-to-analog converter (DAC) to process analog (e.g., audio) signals, an audio codec (e.g., a PCM module) to decode an audio data stream, and other components available in conventional microcontrollers. An antenna 235 receives radio signals. If the receiving unit contains a transceiver 225, then a transmitter/receiver (TR) switch, which may be part of the microcontroller, part of the transceiver or a separate component, may be provided to enable selection of transmit or receive mode for the antenna. If the receiving unit contains a receiver without a transmitter, then a transmitter/receiver (TR) switch is unnecessary. An amplifier 240, which also may be part of the microcontroller or a separate component, amplifies signals that are output through an output port 245. An output port 245, such as a 3.5 mm TRS receptacle (aka audio jack) communicates analog signals to a plugged-in compatible audio input plug of an audio device, such as earphones or headphones. Signals received via the antenna 235 may be filtered by a SAW (surface acoustic wave) filter or other filter and then input into the transceiver. The receiver or transceiver processes or demodulates the received signals. By way of example and not limitation, processing steps may include down-converting the signals to an intermediate frequency and then down-converting to baseband or other frequency, digitally detecting data, extracting the data from the received modulated carrier wave, and other signal processing. A battery 230, which may be disposable or rechargeable, provides electric power for the unit 200.

A variety of other peripherals, such as a USB (Universal Serial Bus) port 250, an on/off switch 255 and a user input device, such as button 265, may be operably coupled to the microcontroller 205.

To play audio, the receiving unit 200 converts received audio data back to an analog wave using the digital-to-analog converter (DAC). The analog wave produced by the DAC is amplified and fed to the output port to produce signals that drive earphones or headphones to audibly output the corresponding sounds. The analog wave produced by the DAC of the receiving unit will be very similar to the original analog wave received by the transmitting unit if the analog-to-digital converter of the transmitting unit sampled at a high sampling rate and employed a suitable quantization level.

Communication between the transmitting unit 100 and the receiving unit 200 may be performed using any compatible communication means, such as bidirectional half-duplex optical communication, RF communication or a serial (e.g., USB) port. By way of example and not limitation, the transmitting unit 100 and the receiving unit 200 may be equipped with means for Infrared Data Association (IrDA) or other optical communication means, such as an LED and photoreceiever, conceptually illustrated as 150, 260 in FIGS. 1 and 2.

In an exemplary embodiment, pulse code modulation (PCM) is employed to transmit quantized samples as digital data through the wireless communication channel. A 64 kbps (=8 kS/s×8 bits/sample) PCM data stream can faithfully convey a high quality digital audio signal. The quantization of the PCM coder is preferably logarithmic, in consideration of the logarithmic sensitivity of the human ear to acoustic signals. The A-law μ-law quantization schemes reflect this sensitivity and provide a lossless coding with high fidelity for music signals. Linear PCM coding, in contrast, is a simpler scheme that uses evenly-spaced quantization levels and is preferable in applications for modem signals, especially higher bit-rate modem signals. Lossless PCM coding digitizes transmit audio signal and uses a coding scheme to generate a PCM data stream that completely describes the sampled signal, to within the limits of the digital sampling and quantization. To enhance fidelity, low volume signals may be amplified in the PCM coding. The amplified signals along with the level of amplification are communicated to the receiver unit. The receiver unit de-amplifies the signals to restore the audio to the correct level of volume for playback. By amplifying the low volume signals, the system enhances the signal to noise ratio and quality of playback.

Various components or peripherals may be operably coupled to the microcontroller of the receiving unit. For example, memory 220, such as a volatile random access memory and/or nonvolatile flash random access memory, may store information. A variety of other peripherals, such as a USB (Universal Serial Bus) port 250, an on/off switch 255 and a user input device, may be coupled to the microcontroller.

As the receiving unit and transmitting unit may be powered by battery power, power conservation is important. To conserve power, the transceiver or receiver in the receiving unit may remain powered down for a determined time interval. After the interval the transceiver of the receiving unit powers up to look for a power-up signal from the transmitting unit. If the receiver does not receive a power-up signal at the scheduled time, then the transceiver of the receiving unit will revert to powered down mode for another time interval. This process continues until the receiving unit receives a power-up signal. When the receiving unit receives a power-up signal, the transceiver of the receiving unit will remain powered-up for the determined time interval. If at the end of the time interval the receiving unit receives another power-up signal, the receiving unit will remain powered up. If at the end of the time interval the receiving unit does not receive another power-up signal, the receiving unit will revert to powered down mode. The transmitting unit and receiving unit are programmed to follow a schedule defined by the time interval. The transmitting unit will send a power-up signal according to the schedule only when the transmitting unit is receiving analog audio signals at the scheduled time. The default is powered down. Thus, if the transmitting unit is switched off, the receiving unit will remain in powered down mode unless and until the transmitting unit is switched on and transmits a power-up signal. While the receiving unit will consume battery power in powered down mode, it will consume less power than when it is operating in power-up mode.

Co-channel interference (CCI), crosstalk from two different transmitters using the same frequency, can be avoided or minimized by determining if a channel is being used by another transmitter and switching to an alternate channel if a checked channel is being used. Alternatively, any of various channel access methods that allows several transmitter units communicating via the same channel to share its capacity. Such methods may, for example, include time division multiple access (TDMA), frequency-division multiple access (FDMA), frequency division duplex (FDD), combinations of any or all the foregoing or some other channel access method that avoids or minimizes CCI. As another alternative, spread-spectrum frequency hopping may be employed, using various randomly chosen frequencies within a designated range of frequencies, changing from one to another on a regular basis, to avoid conflict.

In one embodiment, the receiving unit and/or transmitting unit may contain a Bluetooth compatible wireless communication module configured to communicate on a frequency between 2.402 GHz and 2.480 GHz, the frequency band that has been set aside by international agreement for the use of industrial, scientific and medical devices (ISM). In a Bluetooth embodiment, the transmitter unit may communicate to one or multiple compatibly equipped receiving units and/or to other Bluetooth compatible receivers, including some modern automobile sound systems. In a Bluetooth embodiment, the receiving unit may receive audio from any Bluetooth compatible player. The Bluetooth compatible wireless communication module may be comprised of the wireless communication components described above or may be an additional module coupled to the antenna and microcontroller described above.

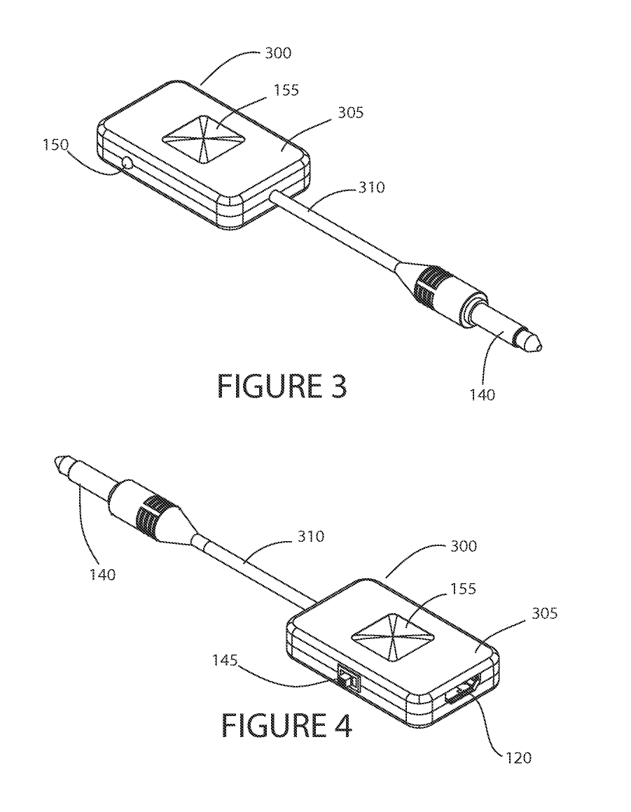

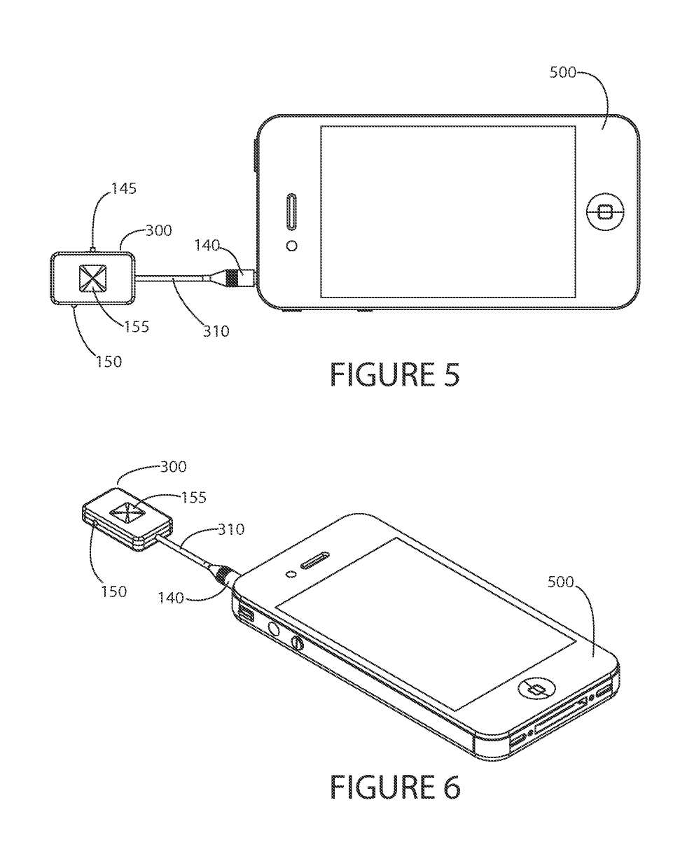

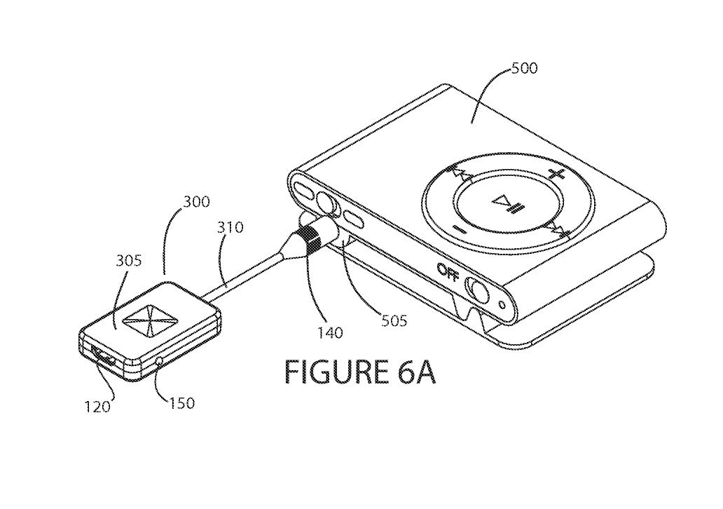

The exterior of an exemplary transmitting unit 300 is conceptually illustrated in a perspective view of FIGS. 3, 5 and 6 and the side view of FIG. 4. A housing 305 contains an electronics module 100 for the transmitting unit 300, as described above in connection with FIG. 1. The invention is not limited to a particular size or shape of housing 305. In a preferred embodiment, the housing 305 is compact, i.e., not much larger than necessary to contain the transmitter electronics module 100. A removable panel or a door may be included to provide access to a battery compartment within the housing 300. An electrical cord 310 with at least two conductive core wires is operably couples an audio plug 140, such as a 3.5 mm TRS connector, supplies analog signals from an audio output socket 505 of an audio device, such as a portable music player 500 (e.g., a smartphone, mp3 player or the like), to the electronics module 100 contained within the housing 305, as illustrated in FIG. 5. A USB (Universal Serial Bus) port 320 is operably coupled to the electronics module 100.

The transmitter module 300 wirelessly transmits an audio data stream based on analog audio output from an audio device. While a portable music player 500 is shown in FIG. 5, the invention is not limited to any particular type of portable player, or to a portable device. Rather, any device that outputs analog audio signals through an audio output port may be used with a transmitter module 300 according to principles of the invention.

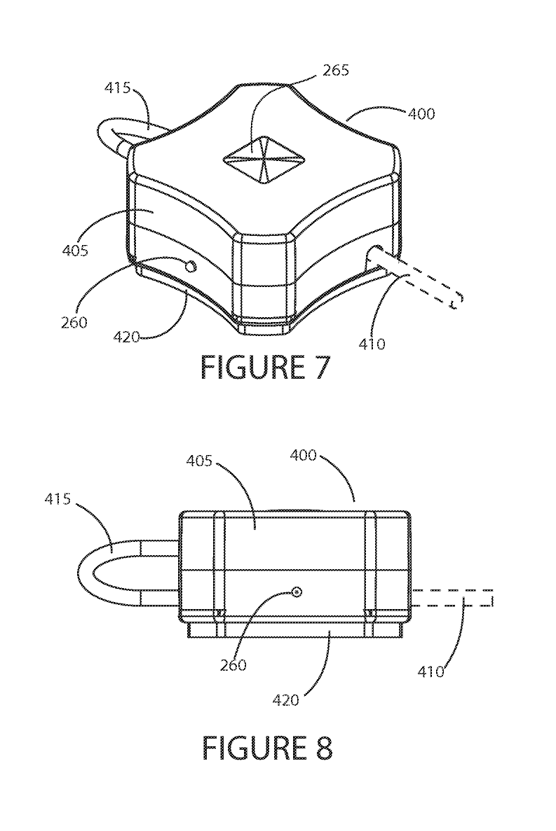

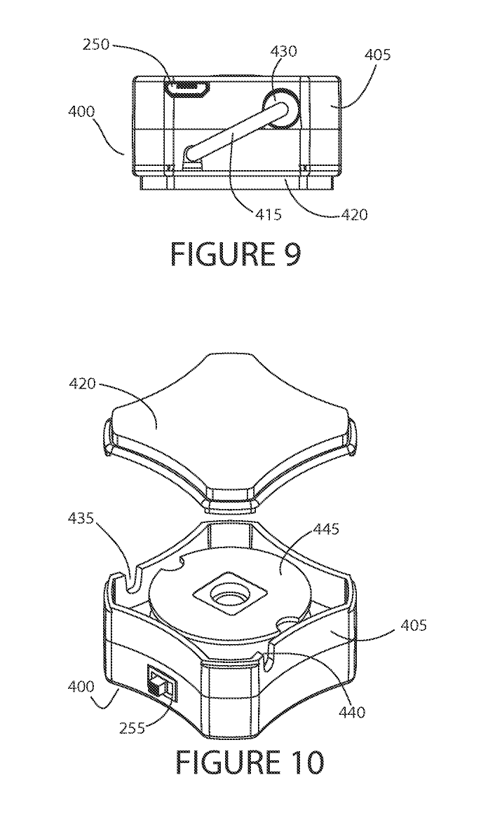

The exterior of an exemplary receiving unit 400 is conceptually illustrated in a perspective view of FIGS. 7, 9 and 10-12 and the side view of FIG. 8. A housing 405 contains an electronics module 200 for the receiving unit 400, as described above in connection with FIG. 2. The invention is not limited to a particular size or shape of housing 405. In a preferred embodiment, the housing 405 is compact, i.e., not much larger than necessary to contain the receiver electronics module 200 and the cord winding spool 445. A removable panel or a door may be included to provide access to a battery compartment within the housing 400. An electrical cord 410 of earphones with an audio plug 430, such as a 3.5 mm TRS connector, for earphones or headphones, supplies analog signals from the receiving unit 400, through the earphone or headphone wires 450 to the speakers 455 of the earphones or headphones. The plug 430 is plugged into a compatible port recessed in the housing 405. The recess defines a channel in which the plug is received and protected. In this manner, the plug is unlikely to break off with the conductive tip stuck in the port. A USB (Universal Serial Bus) port 425 is operably coupled to the electronics module 200.

The receiving unit contains a cord winder. By way of example and not limitation, excess cord 410 may be manually wound around a spool 445 contained within the housing 400. The spool 445 is accessible and removable by removing a removable bottom cover 420. One portion of the cord 410 extends from the earphones or headphones through an inlet 440 into the housing 400. Note that in FIGS. 7, 8 and 11, only a portion of the cord 410 is shown. The full cord 410 is conceptually illustrated as part of earphones in FIG. 12. Excess cord may be neatly wrapped around the spool 445. In the exemplary embodiment illustrated in the Figures, the remaining portion of the cord 415 adjacent to the audio plug 430 extends outwardly from the spool 445 through an outlet 435 of the housing 400. The male audio plug 430 mates with a female analog audio output port 245 of the receiver electronics module 200. In some embodiments, the portion of the cord 415 between the spool 445 and the plug 430 is also contained within the housing 400. In other embodiments, including the embodiments shown in the Figures, that portion of the cord extends from the housing 400.

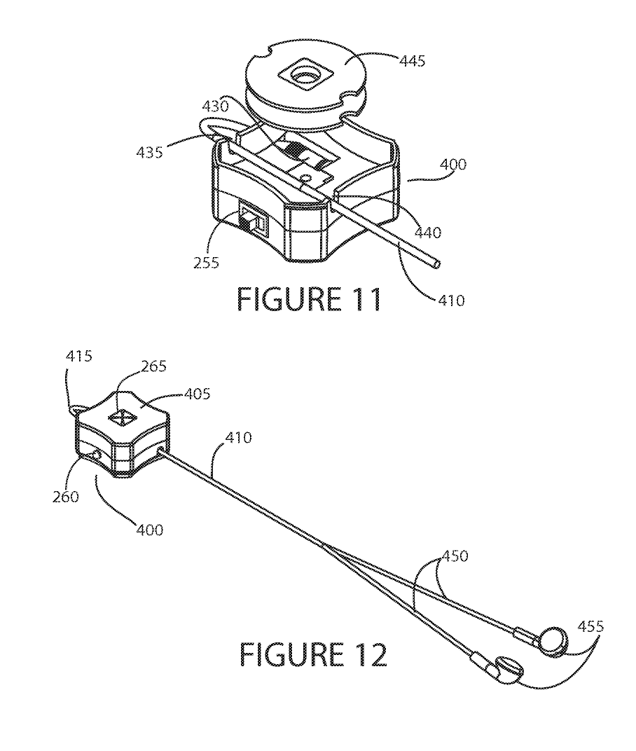

The analog audio output port 245 of the receiver electronics module 200 is contained within the housing 400 and accessible through an opening in the housing. When plugged into the analog audio output port 245, the audio plug 430 is contained within the housing 400. The output port 245 is readily accessible through the opening and by removing the bottom cover 420 and spool 445, as shown in FIGS. 10 and 11. Thus, the housing 405 not only contains excess cord wound on a spool, but also the plug 430 and output port 245. This configuration helps shield and prevent inadvertently breaking off the tip of the audio plug 430 in the analog audio output port 245.

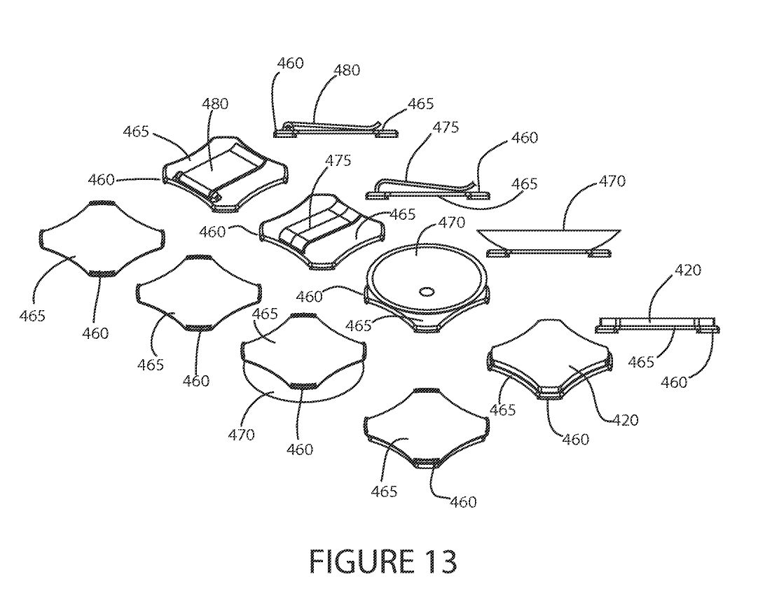

With reference to FIG. 13, various style bottom covers are shown. Each bottom cover includes a base 465 (i.e., panel) that covers the exposed area of the housing 405. A plurality of snap-fit legs 460 connects the cover to the housing 405. In one embodiment, the exposed surface is a flat, generally planar surface 420. It may be cushioned, non-slip, magnetic, phosphorescent (i.e., glow in the dark), and/or adorned with any aesthetic features. In another embodiment, a suction cup 470 is provided. In another embodiment, an integrally formed clip 475 is provided. In yet another embodiment, a hinged clip 480 is provided. Various other surfaces, clips, easel stands, attachments and the like may be utilized without departing from the scope of the invention. These are merely examples of cover features that may be incorporated. The invention is not limited to any particular cover features.

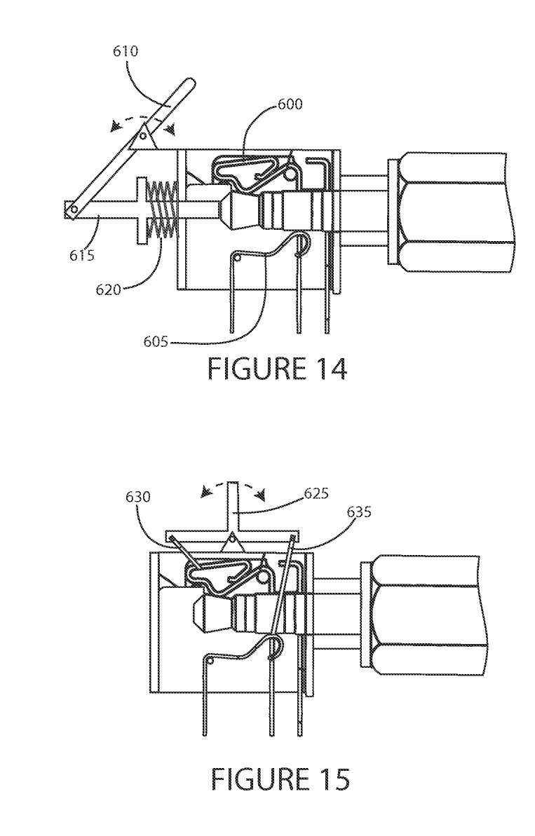

Referring to FIG. 14, an exemplary audio jack port has a plurality of signal contacts 600, 605 (i.e., electrodes) biased to contact sections of an inserted plug. As the port is recessed in the housing as illustrated in FIG. 11, means to facilitate removal is desirable. The signal contacts operate like a leaf spring, deflecting under the influence of the inserted plug. To facilitate withdrawal, a spring-biased lever-actuated ejector pin 615 is provided. Upon actuating the lever 610, the ejector pin 615 is urged towards the plug, compressing the spring 620. Instead of a lever, a slide mechanism or rotating mechanism with a crank shaft may be used. The ejector pin 615 is movable linearly to push (i.e., urge) the plug out of the port. The pin may be controlled by a user-actuable lever, slider or rotating control with appropriate linkage. In lieu of a linearly movable ejector pin, a rotating cam, a pivoting lever an inclined plane (e.g., wedge) may be used to controllably urge the plug from the port. In each case the ejector, whether it be a pin, plane, cam, lever or other mechanical urging mechanism, is movable from and between a position in which the ejector does not push the plug from the port to a position where it pushes the plug from the port. Appropriate linkage, such as shafts, levers, switches, buttons, connectors and the like may couple a user actuatable control to the ejector.

In lieu of or in addition to an ejector, the exemplary audio jack port may have lever-actuated signal contact relief arms, as shown in FIG. 15. The arms 630, 635 draw the biased signal contacts away from the tip of the plug when the lever 625 is actuated. Other mechanical devices, such as wedges may be used to urge the contacts away from the tip of the plug. These features minimize the forces required to insert or withdraw the plug from the port. In doing so, these features facilitate insertion and/or withdrawal while reducing risk of damage to the plug and wires attached to the plug.

For security and interference avoidance reasons it is desirable for a receiver unit to be able to recognize a specific transmitter unit and accept signals only from a properly recognized transmitter unit. Upon coupling a USB port 250 of a receiver unit 200 to a USB port 120 of a transmitter unit 100, the transmitter unit 100 provides a transmitter identifier code to the receiver unit 200. Audio data signals streamed from the transmitter unit 100 to the receiver unit 200 will be prefaced by the transmitter identifier code. The receiver unit 200 will process and emit audio only for signals prefaced by the recognized transmitter identifier code. A plurality of receiver units within wireless communication range may thus be configured to receive and process audio from a transmitter corresponding to a recognized transmitter identifier code. This and/or other techniques may be employed to ensure that a receiver unit 100 produces audio output only from a properly recognized transmitter unit.

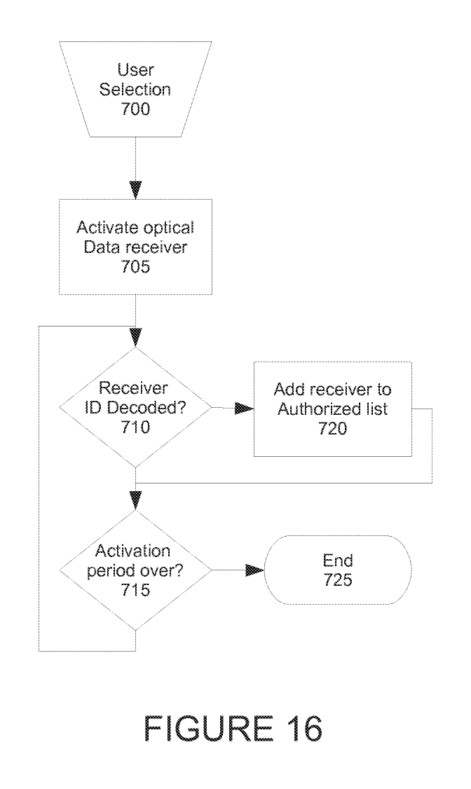

Referring now to FIG. 16 a high level block diagram of an exemplary method of coupling a receiving unit to a transmitting unit, according to principles of the invention is provided. Initially, a user selects the coupling operation by user input 700. The user input may entail pressing a button, pressing a button a determined number of times in succession, holding the button in the depressed state for a determined period of time, or some other identifiable user input that can be associated with the coupling operation. After selection of the coupling operation, a means for communicating data between a transmitting unit 100 and receiving unit 200 is activated as in step 705. The means for communication may comprise an optical transmitter and receiver. The transmitting unit 100 receives and decodes a receiver ID, as in step 710. If the receiver ID is received and decoded, the receiver is added to an authorized list. If the receiver ID is not received or not decoded, then the transmitting unit either waits until it is received and decoded, or optically sends a request for the receiver ID to the receiving unit. The steps of receiving and decoding the receiver ID and adding the receiver to the authorized list is repeated for each receiving unit to be coupled. When each receiving unit to be coupled has sent its receiver ID, the session terminates. Accordingly, in step 715 a determination is made if the activation period is completed. Completion may be determined based upon user input (e.g., pressing a button), or an elapsed time period (e.g., 15 seconds) during which no additional receiver ID is received. Upon completion, the process ends, as in step 725.

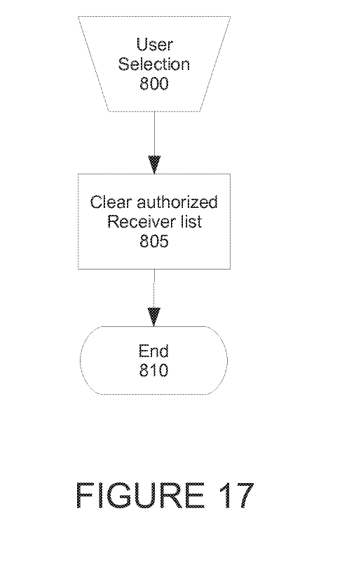

FIG. 17 is a high level block diagram of a method of clearing a list of authorized receiving units, according to principles of the invention. Initially, a user selects the clearing operation by user input 800. The user input may entail pressing a button, pressing a button a determined number of times in succession, holding the button in the depressed state for a determined period of time, or some other identifiable user input that can be associated with the coupling operation. After selection of the clearing operation, the receiver ID for the receiver to be cleared from the list is provided (e.g., from the receiving unit) or the entire list is cleared, as in step 805. Upon clearing, the process ends, as in step 810.

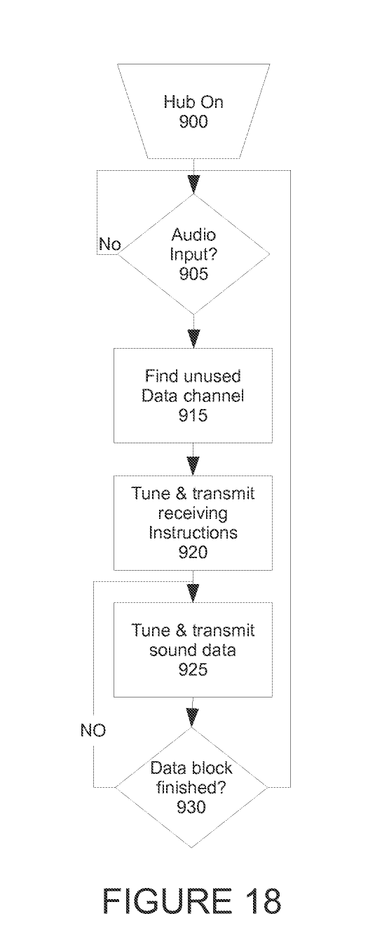

FIG. 18 is a high level block diagram of a method of a method of communicating data between a transmitting unit and a receiving unit, according to principles of the invention. In step 900 the hub, i.e., transmitting unit 100 is turned on 900. The unit waits for audio input in step 905. When audio input is available, an unused data channel is identified as in step 915. Then the transmitter unit 100 tunes to the data channel and transmits receiving instructions for coupled (i.e., paired) receivers, as in step 920. Then audio data is transmitted in packets over the tuned in available data channel, as in step 925, until all packets comprising a block of data has been sent, as in step 930. When all data has been sent control returns to step 905.

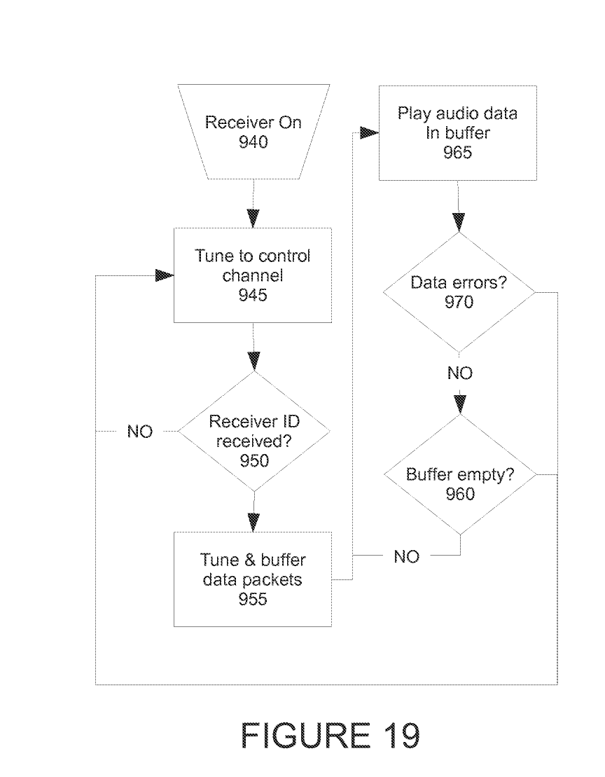

FIG. 19 is a high level block diagram of a method of a receiving data and playing audio via a receiving unit, according to principles of the invention. In step 940 the receiving unit 200 is turned on 940. The unit tunes to a control channel for communication with the hub, as in step 945. If the receiver ID is received, as in step 950, the receiving unit tunes to the corresponding data channel and receives and buffers transmitted data packets, as in step 955. The received data packets are played, as in step 965. If data errors interfere with playing, the receiver re-tunes and receives data again, in accordance with steps 945 and 950. If the data is played, the buffer is checked as in step 970. As long as the buffer is not empty, data is received and buffered data is played, as in steps 955, 960. When the buffer is empty, as determined in step 960, control passes to waits for audio input in step 905. When audio input is available, an unused data channel is identified as in step 915. Then the transmitter unit 100 tunes to the data channel and transmits receiving instructions for coupled (i.e., paired) receivers, as in step 920. Then audio data is transmitted in packets over the tuned in available data channel, as in step 925, until all packets comprising a block of data has been sent, as in step 930. When all data has been sent control returns to step 905.

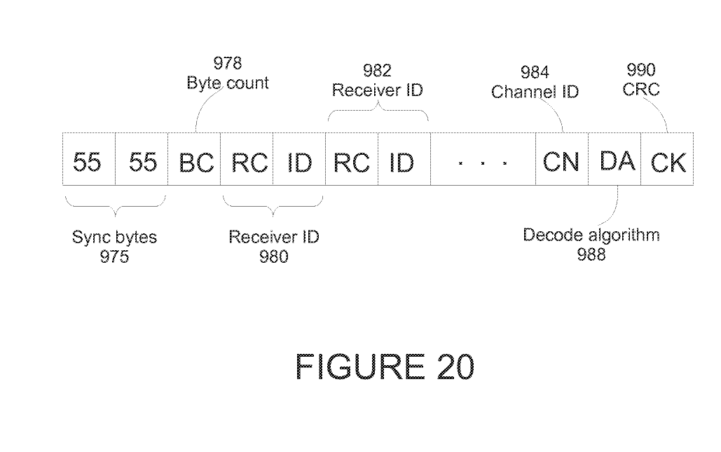

FIG. 20 is a high level block diagram of a data structure for communicating data between a transmitting unit and a receiving unit, according to principles of the invention. a format for transmission and storage of audio data in a container format encapsulating packetized elementary streams, with error correction and stream synchronization features for maintaining transmission integrity when the signal is degraded. A packet is the basic unit of data in a transport stream. It starts with one or more sync bytes 975, a byte count 978 and a header that includes receiver IDs 980, 982. The rest of the packet consists of payload (i.e., audio data), channel ID 984, decode algorithm information 988 and a cyclic redundancy check (CRC) to detect any changes to the raw data. Thus, the stream identifies the receiving units, method to be used for decoding, and channel, while providing the audio data with error detection information.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A wireless audio transmission system for an earphone having a wire connecting an audio output device to an earphone plug, and a portable audio player with a first analog audio output port through which the player communicates first analog audio signals, said wireless audio transmission system comprising:
a transmitting unit including:
an audio plug configured to operably couple the transmitting unit to the audio player by mating with the first analog audio output port of the audio player, and
an audio transmitting module generating, from the first analog audio signals, audio data, and wirelessly transmitting the audio data; and
a receiving unit including:
a housing having a plug channel, and
a second analog audio output port recessed in the housing in the plug channel and configured to mate with the earphone plug, said plug channel containing and shielding the earphone plug in the channel when the earphone plug mates with the second analog audio output port, and
an audio receiving module receiving audio data wirelessly transmitted by the transmitting unit, and generating a second analog audio output from the received audio data, and communicating the second analog audio output through the second analog audio output port.

2. The wireless audio transmission system according to claim 1, further comprising a plug ejector including an ejector in the second analog audio output port, said ejector being moveable from a first position to a second position, in the second position said ejector urging the earphone plug out of the second analog audio output port, and in the first position said ejector not urging the earphone plug out of the second analog audio output port.

3. The wireless audio transmission system according to claim 2, said ejector comprising an ejection pin linearly moveable from the first position to the second position.

4. The wireless audio transmission system according to claim 3, said plug ejector including a pivoting control lever coupled to the ejection pin, said pivoting control lever moving the ejection pin between the first position and the second position.

5. The wireless audio transmission system according to claim 3, said plug ejector including a rotary control coupled to the ejection pin, said rotary control moving the ejection pin between the first position and the second position.

6. The wireless audio transmission system according to claim 3, said plug ejector including a sliding control coupled to the ejection pin, said sliding control moving the ejection pin between the first position and the second position.

7. The wireless audio transmission system according to claim 2, said ejector comprising an inclined plane moveable between the first position and the second position.

8. The wireless audio transmission system according to claim 2, said ejector comprising a cam rotatable between the first position and the second position.

9. The wireless audio transmission system according to claim 2, said ejector comprising a lever pivotable between the first position and the second position.

10. The wireless audio transmission system according to claim 1, further comprising a biased conductive contact in the second analog audio output port, said biased conductive contact being deflectable from a released position to an engaged position, and being in the engaged position when undisturbed, and in the engaged position contacting the earphone plug and resisting removal of the earphone plug from the second analog audio output port, and a deflector controllably moving the biased conductive contact from the engaged position to the released position to facilitate removal of the earphone plug from the second analog audio output port.

11. The wireless audio transmission system according to claim 2, further comprising a biased conductive contact in the second analog audio output port, said biased conductive contact being deflectable from a released position to an engaged position, and being in the engaged position when undisturbed, and in the engaged position contacting the earphone plug and resisting removal of the earphone plug from the second analog audio output port, and a deflector controllably moving the biased conductive contact from the engaged position to the released position to facilitate removal of the earphone plug from the second analog audio output port.

12. The wireless audio transmission system according to claim 1, further comprising a spool contained in the housing of the receiving unit, said spool containing a portion of the wire wound thereupon and said housing including an opening for the wire.

13. The wireless audio transmission system according to claim 12, said housing including a removable panel providing access to the contained spool.

14. The wireless audio transmission system according to claim 13, said removable panel having an interior side facing the spool and an exterior side, said exterior side including a clip for supporting the receiving unit on a clipped object.

15. The wireless audio transmission system according to claim 13, said removable panel having an interior side facing the spool and an exterior side, said exterior side including a magnet for supporting the receiving unit on a magnetically attracted object.

16. The wireless audio transmission system according to claim 13, said removable panel having an interior side facing the spool and an exterior side, said exterior side including a suction cup for supporting the receiving unit on a magnetically attracted object.

17. The wireless audio transmission system according to claim 1, the transmitting unit further comprising a first optical emitter and a first optical receiver, and the receiving unit further comprising a second optical emitter and a second optical receiver, said transmitting unit communicating with the receiving unit via the first optical emitter and the first optical receiver, and said receiving unit communicating with the transmitting unit via the second optical emitter and the second optical receiver.

18. The wireless audio transmission system according to claim 1, the audio receiving module of the receiving unit communicating an operating signal to the audio transmitting module of the transmitting unit when the receiving unit is operating, and the transmitting module of the transmitting unit operating intermittently until the audio receiving module of the receiving unit communicates an operating signal to the transmitting module of the transmitting unit.

19. The wireless audio transmission system according to claim 1, said transmitting unit including a first user-actuatable input control and said receiving unit including a second user-actuatable input control, and said receiving unit transmitting a receiving unit ID to the transmitting unit when the second user-actuatable input control is actuated and said transmitting unit saving the receiving unit ID when the first user-actuatable input control is actuated, and audio data transmitted from the transmitting unit being transmitted in a stream including the receiver ID, and said receiving unit playing the audio data only if the stream includes the receiver ID.

20. The wireless audio transmission system according to claim 19, said transmitting module of the transmitting unit amplifying the audio data in PCM coding to a determined level of amplification, said amplified audio data and determined level of amplification being included in the stream transmitted from the transmitting unit to the receiving unit.
